(19) United States
(12) Patent Application Publication
(10) Pub. No.: US 2025/0081264 A1
(43) Pub. Date: Mar. 6, 2025

(54) WIRELESS NETWORK SYSTEM, CONNECTION PAIRING METHOD, AND COMPUTER-READABLE STORAGE MEDIUM FOR MULTIPLE ELECTRONIC DEVICES

(71) Applicant: AVer Information Inc., New Taipei City (TW)

(72) Inventors: Xuan-Yuan HUANG, New Taipei City (TW); Jhan-Jhang LIAO, New Taipei City (TW); Cheng-Mou TSAI, New Taipei City (TW)

(21) Appl. No.: 18/817,397

(22) Filed: Aug. 28, 2024

(30) Foreign Application Priority Data
Aug. 28, 2023 (TW) 112132294

(51) Int. Cl. H04W 76/14; H04W 88/04

(52) U.S. Cl. CPC H04W 76/14; H04W 88/04

(57) ABSTRACT

A connection pairing method is used to establish a wireless transmission connection between a first electronic device and a second electronic device. Each electronic device is capable of operating in a wireless network mode and/or a network hotspot mode. The connection pairing method includes disabling the network hotspot mode of the first electronic device, connecting the first electronic device to the hotspot of the second electronic device, and transmitting the hotspot connection information of the first electronic device to the second electronic device; upon receiving the hotspot connection information of the first electronic device, setting the second electronic device to wireless network mode and enabling the network hotspot mode of the first electronic device; and establishing a hotspot connection between the second electronic device and the first electronic device based on the hotspot connection information. The present disclosure also discloses a wireless network system and a computer-readable storage medium.

### RELATED APPLICATIONS

This application claims priority to Taiwan Application Serial Number 112132294, filed Aug. 28, 2023, which is herein incorporated by reference.

### BACKGROUND

### Technical field

The present disclosure relates to a wireless network system, a connection pairing method, and a computer-readable storage medium for electronic devices.

### Description of Prior Art

With the advancement of communication and image capture technologies, using a document camera to transmit data with a personal computer (PC) over a wireless network has become a mature and common application, and such technology, along with a router, allows interactions with more electronic devices.

In the current technologies, there are two main methods to establish a wireless network connection between a document camera and a PC, which are shown below with reference to FIG. 1A and FIG. 1B, respectively.

As shown in FIG. 1A, the first method is applied by a PC 101, a wireless network card (Wi-Fi dongle) 102, and a document camera 103. The Wi-Fi dongle 102 is usually connected to the PC 101 via a USB interface, and the PC 101 may then connect to a hotspot of the document camera 103 via the Wi-Fi dongle 102. In addition, in this architecture, the PC 101 may connect to the internet through a router (not shown) connected to a built-in network card (not shown).

As shown in FIG. 1B, the second method is applied by a PC 111, a router 112, and a document camera 113. First, the PC 111 may connect to a hotspot of the document camera 113 via a built-in network card. Then, the PC 111 may send a router connection information to the document camera 113, and then disconnects from the hotspot. Next, the PC 111 and the document camera 113 are respectively connected to the router 112 according to the router connection information.

The first method requires the user to purchase an external wireless card to complete the connection between the PC and the document camera, resulting in additional hardware and cost. The second method requires the user to operate the PC to select the corresponding hotspot of the document camera, send the router connection information to the document camera, disconnect from the hotspot, and perform many other manual setup and operation steps. Such cumbersome steps also cause inconvenience to the user.

Therefore, it is one of the most important issues to provide a wireless network system, a connection pairing method, and a computer-readable storage medium that may quickly and conveniently connect electronic devices in order to reduce the cost of the devices and save time and steps for the user to perform manual operations.

### SUMMARY

In view of the foregoing, the purpose of the present disclosure is to provide a wireless network system, a connection pairing method, and a computer-readable storage medium.

For the above purpose, the present disclosure provides a connection pairing method for establishing a wireless transmission connection between a first electronic device and a second electronic device. The first electronic device and the second electronic device are capable of operating in a wireless network mode and/or a network hotspot mode, respectively. The connection pairing method includes the following steps. First, disable the network hotspot mode of the first electronic device and enable the network hotspot mode of the second electronic device. Next, the first electronic device is connected to a hotspot of the second electronic device, and transmits a hotspot connection information of the first electronic device to the second electronic device. Next, after the second electronic device receives the hotspot connection information from the first electronic device, the second electronic device is set to the wireless network mode and the network hotspot mode of the first electronic device is enabled. As a result, the second electronic device establishes a hotspot connection with the first electronic device based on the hotspot connection information.

In addition, for the above purpose, the present disclosure provides another connection pairing method for establishing a wireless transmission connection between a first electronic device and a second electronic device. The first electronic device and the second electronic device are capable of operating in a first network connection mode and/or a second network connection mode, respectively. The connection pairing method includes the following steps. First, disable the second network connection mode of the first electronic device and enable the second network connection mode of the second electronic device. Next, communicatively connect the first electronic device to the second electronic device, and transmits a network connection information of the first electronic devices to the second electronic device. Then, after the second electronic device receives the network connection information of the first electronic device, the second electronic device is set to the first network connection mode and the second network connection mode of the first electronic device is enabled. As a result, the second electronic device establishes a wireless communication connection with the first electronic device based on the network connection information.

Further, for the above purpose, the present disclosure provides a wireless network system for electronic devices including a first electronic device and a second electronic device. The first electronic device and the second electronic device are capable of operating in a wireless network mode and/or a network hotspot mode, respectively. The wireless network system includes connecting the first electronic device to a hotspot of the second electronic device in a state in which the network hotspot mode of the first electronic device is disable and the network hotspot mode of the second electronic device is enable, and transmitting a hotspot connection information of the first electronic device to the second electronic device. After the second electronic device receives the hotspot connection information of the first electronic device, the second electronic device is set to the wireless network mode and the network hotspot mode of the first electronic device is enabled. The second electronic device establishes a hotspot connection with the first electronic device based on the hotspot connection information.

Further, for the above purpose, the present disclosure provides a computer-readable storage medium for storing instructions executable by a computer device that enables a first electronic device and a second electronic device to be connected and paired. The first electronic device and the second electronic device are capable of operating in a wireless network mode and/or a network hotspot mode, respectively. When the computer device executes the instructions, the computer device is configured to perform the following steps. First, the network hotspot mode of the first electronic device is disabled and the network hotspot mode of the second electronic device is enabled. Next, the first electronic device is connected to a hotspot of the second electronic device, and the hotspot connection information of the first electronic device is transmitted to the second electronic device. Next, after the second electronic device receives the hotspot connection information of the first electronic device, the second electronic device is set to the wireless network mode and the network hotspot mode of the first electronic device is enabled. Finally, the second electronic device establishes a hotspot connection with the first electronic device based on the hotspot connection information.

In view of the foregoing, the wireless network system, the connection pairing method, and the computer-readable storage medium of the present disclosure may conveniently provide a wireless connection (hotspot connection) between multiple electronic devices without the need for additional networking devices.

### BRIEF DESCRIPTION OF THE DRAWINGS

FIG. 1A is a schematic diagram showing an architecture of a first known network connection system of electronic devices.

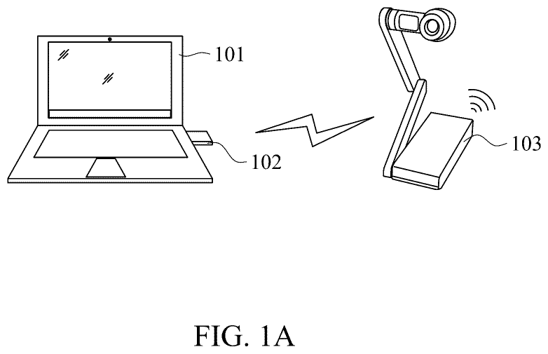

FIG. 1B is a schematic diagram showing an architecture of a second known network connection system of electronic devices.

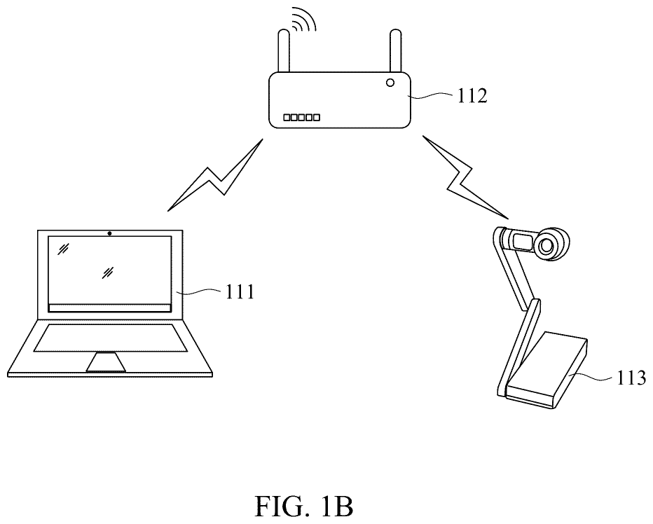

FIG. 2 is a schematic diagram showing an architecture of a wireless network system of electronic devices according to a preferred embodiment of the present disclosure.

FIG. 3 is a flowchart showing the execution of a connection pairing method of electronic devices according to a preferred embodiment of the present disclosure.

### DETAILED DESCRIPTION

In order to enable those skilled in the art to understand the contents of the present disclosure and to implement the contents of the present disclosure accordingly, it is hereby described as follows in conjunction with appropriate embodiments and drawings, wherein the same components are described by the same component symbols.

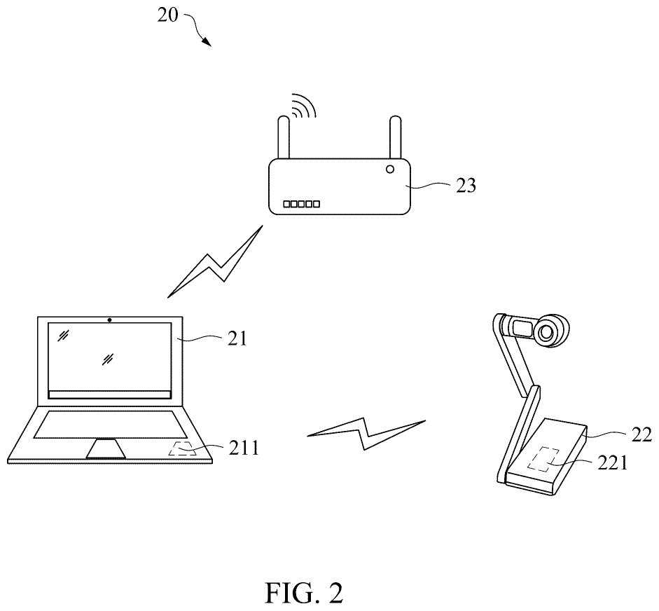

Referring to FIG. 2, a preferred embodiment of the present disclosure, a wireless network system 20 for electronic devices includes a first electronic device 21, a second electronic device 22, and a networking device 23. The first electronic device 21 may be a person's computer, including, but not limited to, an electronic device capable of installing an operating system, such as a desktop computer or a laptop computer. The operating system is, for example, Windows 10 or Windows 11 of Microsoft Corporation, or a similar operating system. The second electronic device 22 may include, but is not limited to, a document camera or an electronic device with one or more camera lenses. The networking device 23 may include, but is not limited to, a router, a Wi-Fi router, a network card, and combinations thereof.

A first network unit 211 is built into the first electronic device 21 and includes, but is not limited to, a wireless network card. In this embodiment, the setting or control of the operating system of the first electronic device 21 enables the first network unit 211 to operate in different network modes simultaneously, for example, to operate in a wireless network mode (Wi-Fi mode) and a network hotspot mode simultaneously. In other words, the first electronic device 21 may have both a network connection and a hotspot connection. There is no limitation on implementing simultaneous operation, with one embodiment having a portion of the bandwidth operating in the wireless network mode and another portion of the bandwidth operating in the network hotspot mode.

A second network unit 221 is built into the second electronic device 22 and is also operable in the wireless network mode and the network hotspot mode. In this embodiment, the second electronic device 22 is selectable to operate in either the wireless network mode or the network hotspot mode.

The networking device 23 is capable of connecting to the internet via PPPOE, DHCP, PPTP, L2TP, or static IP, and sharing the wireless network to the first electronic device 21, the second electronic device 22, other devices or clients. In this embodiment, the first electronic device 21 and the networking device 23 are network-connected to transmit or receive internet data, the first electronic device 21 and the second electronic device 22 are hotspot-connected to transmit or receive images, and the bandwidth for the network connection is greater than the bandwidth for the hotspot connection. Further, the first network unit 211 is operable for both the network connection and the hotspot connection, and the bandwidth allocated for the network connection is greater than the bandwidth allocated for the hotspot connection.

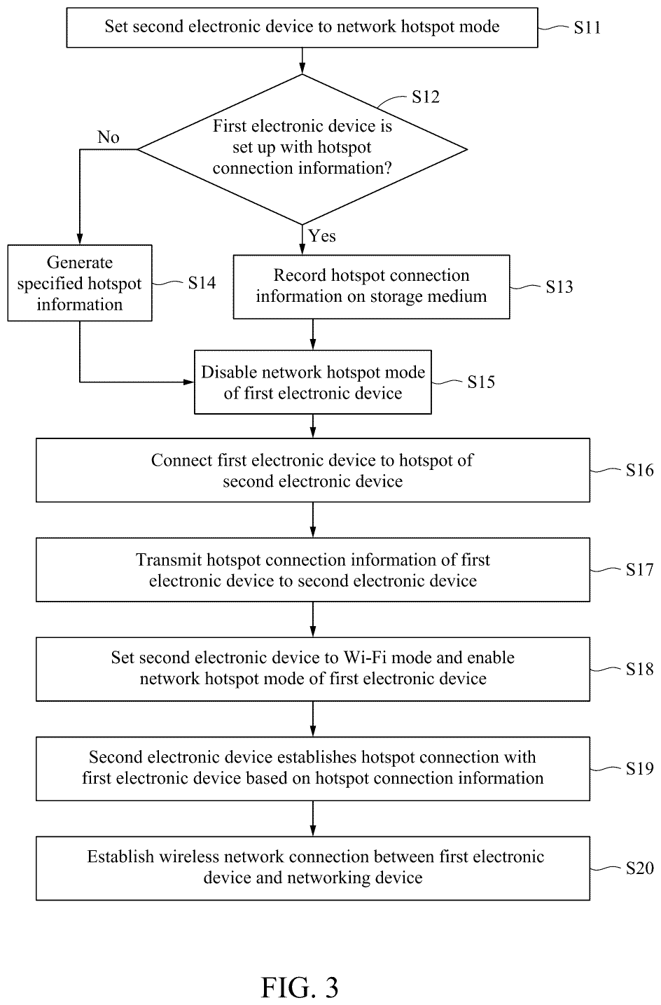

Continuing from the above, reference is made to FIGS. 2 and 3 to illustrate a connection pairing method according to a preferred embodiment of the present disclosure, which includes Steps S11 to S20. It should be noted that the absence of any reference to the order of the steps in this embodiment means that the order of execution of the steps may be alternated or simultaneous without limitation. As mentioned above, the connection pairing method is used to establish a wireless transmission connection between the first electronic device 21 and the second electronic device 22. The first electronic device 21 and the second electronic device 22 are capable of operating in a wireless network mode (Wi-Fi mode) and a network hotspot mode, respectively. In this embodiment, the first electronic device 21 is capable of operating in both the Wi-Fi mode and the network hotspot mode simultaneously, while the second electronic device 22 is capable of selectively operating in either the Wi-Fi mode or the network hotspot mode. In other embodiments, it is not limited to this setting, for example, the second electronic device 22 is capable of operating in both the Wi-Fi mode and the network hotspot mode simultaneously.

At Step S11, the second electronic device 22 is set to the network hotspot mode. In the network hotspot mode, the second electronic device 22 broadcasts a hotspot for other devices or clients to be able to search for and select to connect to.

At Step S12, a check is made to determine whether the first electronic device 21 is set up with a hotspot connection information. The hotspot connection information is the connection information required for an external device or client to connect to a hotspot of the first electronic device 21, including but not limited to a service set identifier (SSID) and a password. In this embodiment, the existence of the hotspot connection information may be automatically checked by software or applications installed on the first electronic device 21. In other embodiments, the hotspot connection information may be checked by a user.

At Step S13, the hotspot connection information is recorded on the storage medium when it exists. The storage medium includes, but is not limited to, a flash memory (Flash), a random access memory (RAM), a read-only memory (ROM), a hard disk drive (HDD/SSD), an external hard drive, or a similar storage medium.

At Step S14, a specified hotspot information is generated when the hotspot connection information does not exist. The specified hotspot information also includes, but is not limited to, a SSID and a password. In some embodiments, the specified hotspot information may be generated automatically by software or applications. In other embodiments, the specified hotspot information may be generated by manual input by a user.

At Step S15, the network hotspot mode of the first electronic device 21 is disabled to make it easier for the first electronic device 21 to discover other hotspots and establish connections with them.

After the first electronic device 21 searches for and discovers the hotspot of the second electronic device 22, the first electronic device 21 is connected to the hotspot of the second electronic device 22 at Step S16. At Step S16, the first electronic device 21 and the second electronic device 22 may agree with each other on the status of the operating mode by means of a handshake technique.

At Step S17, after the connection, the hotspot connection information of the first electronic device 21 is transmitted to the second electronic device 22. In this embodiment, the second electronic device 22 may create a connection record based on the hotspot connection information of the first electronic device 21, so that the second electronic device 22 may automatically connect to the first electronic device 21 after searching for the hotspot of the first electronic device 21 in the future.

It should be noted that Step S11 of enabling the network hotspot mode of the second electronic device 22 may be performed at any time prior to Step S17, there being no restriction on the order of precedence.

At Step S18, after the second electronic device 22 receives the hotspot connection information from the first electronic device 21, the second electronic device 22 is set to the Wi-Fi mode and the network hotspot mode of the first electronic device 21 is enabled. In this embodiment, the second electronic device 22 may be set to the Wi-Fi mode by the software or application program in the first electronic device 21 that executes the present connection pairing method. In addition, the second electronic device 22 is disconnected from the first electronic device 21 after it is set to the Wi-Fi mode. Furthermore, in the network hotspot mode, the first electronic device 21 broadcasts a hotspot for other devices or clients to be able to search for and select to connect to.

After the second electronic device 22 discovers the hotspot of the first electronic device 21, the second electronic device 22 establishes a hotspot connection with the first electronic device 21 based on the hotspot connection information at Step S19. Since the second electronic device 22 is in the Wi-Fi mode, after searching for the hotspot of the first electronic device 21, the second electronic device 22 attempts to connect to the first electronic device 21 and establishes the hotspot connection with the first electronic device 21 based on the hotspot connection information previously received from the first electronic device 21.

At Step S20, a wireless network connection is established between the first electronic device 21 and the networking device 23 to transmit internet data. There is no restriction on the order of performing Step S20, which may be performed at any time after the first electronic device 21 and the second electronic device 22 are disconnected at Step S17.

After the first electronic device 21 establishes the hotspot connection with the second electronic device 22, the second electronic device (the document camera) 22 may transmit an image of an object placed thereon to the first electronic device (the personal computer) 21, and the first electronic device 21 may then transmit the image to a display connected thereto, or to other clients via the internet through the networking device 23.

In summary, the wireless network system, the connection pairing method and the computer-readable storage media for the electronic devices of the present disclosure is achieved by the primary first electronic device (personal computer) actively transmitting the setting data to the second electronic device (document camera), and then the second electronic device automatically establishes a hotspot connection with the first electronic device. The disclosure is effective in using less hardware equipment (e.g., eliminating the need for an external wireless network card) and in making it easier for the user to operate and use by automatically establishing the connection between the first electronic device and the second electronic device.

Although the present disclosure has been disclosed in embodiments as above, the embodiments are not intended to limit the present disclosure, and those skilled in the art may make some modifications and embellishments within the spirit and scope of the present disclosure, therefore, the scope of protection of the present disclosure shall be defined in the appended claims.

What is claimed is:

1. A connection pairing method for establishing a wireless transmission connection between a first electronic device and a second electronic device, the first electronic device and the second electronic device being capable of operating in a wireless network mode and/or a network hotspot mode, respectively, and the connection pairing method comprising:
disabling the network hotspot mode of the first electronic device and enabling the network hotspot mode of the second electronic device;
connecting the first electronic device to a hotspot of the second electronic device, and transmitting a hotspot connection information of the first electronic device to the second electronic device;
setting the second electronic device to the wireless network mode and enabling the network hotspot mode of the first electronic device after the second electronic device receives the hotspot connection information of the first electronic device; and
establishing, by the second electronic device, a hotspot connection with the first electronic device based on the hotspot connection information.

2. The connection pairing method according to claim 1, before disabling the network hotspot mode of the first electronic device, the connection pairing method further comprises:
recording the hotspot connection information in response to the hotspot connection information existing in the first electronic device.

3. The connection pairing method according to claim 2, further comprising:
generating a specified hotspot information in response to the hotspot connection information not existing.

4. The connection pairing method according to claim 1, wherein the first electronic device establishes a network connection with a networking device in response to the second electronic device establishing the hotspot connection with the first electronic device.

5. The connection pairing method according to claim 4, wherein a bandwidth of the network connection is greater than a bandwidth of the hotspot connection.

6. The connection pairing method according to claim 1, wherein the first electronic device is a computer device and the second electronic device is a document camera.

7. A connection pairing method for establishing a wireless transmission connection between a first electronic device and a second electronic device, the first electronic device and the second electronic device being capable of operating in a first network connection mode and/or a second network connection mode, respectively, and the connection pairing method comprising:
disabling the second network connection mode of the first electronic device, and enabling the second network connection mode of the second electronic device;
communicatively connecting the first electronic device to the second electronic device, and transmitting a network connection information of the first electronic device to the second electronic device;
setting the second electronic device to the first network connection mode and enabling the second network connection mode of the first electronic device after the second electronic device receives the network connection information of the first electronic device; and
establishing, by the second electronic device, a wireless communication connection with the first electronic device based on the network connection information.

8. The connection pairing method according to claim 7, wherein the first network connection mode is a wireless network mode and the second network connection mode is a network hotspot mode.

9. A wireless network system of electronic devices comprising a first electronic device and a second electronic device, the first electronic device and the second electronic device being capable of operating in a wireless network mode and/or a network hotspot mode, respectively, and the wireless network system comprising:
connecting the first electronic device to a hotspot of the second electronic device in a state in which the network hotspot mode of the first electronic device is disable and the network hotspot mode of the second electronic device is enable, and transmitting a hotspot connection information of the first electronic device to the second electronic device;
setting the second electronic device to the wireless network mode and enabling the network hotspot mode of the first electronic device after the second electronic device receives the hotspot connection information of the first electronic device; and
establishing, by the second electronic device, a hotspot connection with the first electronic device based on the hotspot connection information.

10. The wireless network system of the electronic devices according to claim 9, further comprising a networking device, wherein in the state where the second electronic device establishes the hotspot connection with the first electronic device, the first electronic device further establishes a network connection with the networking device.

11. The wireless network system of the electronic devices according to claim 9, wherein a bandwidth of the network connection is greater than a bandwidth of the hotspot connection.

12. A computer-readable storage medium for storing instructions executable by a computer device that enables a first electronic device and a second electronic device to be connected and paired, wherein the first electronic device and the second electronic device are capable of operating in a wireless network mode and/or a network hotspot mode, respectively, and wherein when the computer device executes the instructions, the computer device is configured to perform steps comprising:
disabling the network hotspot mode of the first electronic device and enabling the network hotspot mode of the second electronic device;
connecting the first electronic device to a hotspot of the second electronic device, and transmitting a hotspot connection information of the first electronic device to the second electronic device;
setting the second electronic device to the wireless network mode and enabling the network hotspot mode of the first electronic device after the second electronic device receives the hotspot connection information of the first electronic device; and
establishing, by the second electronic device, a hotspot connection with the first electronic device based on the hotspot connection information.
